(19) United States
(12) Patent Application Publication
(10) Pub. No.: US 2025/0133590 A1
(43) Pub. Date: Apr. 24, 2025

(54) ACCESS POINT APPARATUS, AND COMMUNICATION METHOD

(71) Applicant: SHARP KABUSHIKI KAISHA, Sakai City, Osaka (JP)

(72) Inventors: HIROMICHI TOMEBA, Sakai City, Osaka (JP); ATSUSHI SHIRAKAWA, Sakai City, Osaka (JP); HIDEO NAMBA, Sakai City, Osaka (JP)

(21) Appl. No.: 18/684,870

(22) PCT Filed: Sep. 22, 2022
(86) PCT No.: PCT/JP2022/035325

§ 371 Date: Feb. 20, 2024

(30) Foreign Application Priority Data
Sep. 28, 2021 (JP) 2021-157575

(51) Int. Cl. H04W 74/0808; H04W 72/0446

(52) U.S. Cl. CPC H04W 74/0808; H04W 72/0446

(57) ABSTRACT

An access point apparatus for communicating with multiple station apparatuses includes a transmitter that transmits a trigger frame triggering frame transmission performed by each of the multiple station apparatuses, and a receiver that performs carrier sense to reserve multiple radio resources in time periods with different lengths. The trigger frame includes information indicating the time periods for the multiple radio resources reserved by the receiver.

### TECHNICAL FIELD

The present invention relates to an access point apparatus, and a communication method.

This application claims priority to JP 2021-157575 filed on Sep. 28, 2021, the contents of which are incorporated herein by reference.

### BACKGROUND ART

The specification of IEEE 802.11ax for realizing even higher speeds than with IEEE 802.11, which is a wireless Local Area Network (LAN) standard, have been standardized by The Institute of Electrical and Electronics Engineers Inc. (IEEE), and wireless LAN devices conforming to the specification draft have emerged on the market. Activities for standardizing IEEE 802.11be as a standard subsequent to IEEE 802.11ax have been started in recent days. As wireless LAN devices are rapidly widely used, studies are in progress, in standardizing IEEE 802.11be, to further improve a throughput per user in environments where wireless LAN devices are densely located.

In a wireless LAN, frames can be transmitted using unlicensed bands that enable radio communication without permission (license) from a country or a region. The wireless LAN specifications include an infrastructure mode in which multiple station apparatuses access and communicate with an access point apparatus and an ad hoc mode in which station apparatuses communicate directly with each other (direct link, direct link communication, Direct Link). Recently, the number of use cases has been increasing in which various devices are equipped with a wireless LAN function and not all the devices need to communicate with an access point apparatus.

Therefore, for the IEEE 802.11be standardization, discussion has been made on a communication mode in which an access point apparatus performs, on direct communication between station apparatuses, management and control including resource management (see NPL 1). In a case that an access point apparatus capable of recognizing the utilization situation of peripheral radio resources can manage the direct communication between station apparatuses, radio resources can be utilized more flexibly than in the conventional ad hoc mode.

### CITATION LIST

### Non Patent Literature

NPL 1: IEEE 802.11-20/1938-08, June 2021

### SUMMARY OF INVENTION

### Technical Problem

Since an access point apparatus manages radio resources, a pair of station apparatuses communicating directly with each other can be simultaneously configured. However, an increase in the number of station apparatuses communicating at the same time also means an increase in the amount of interference to the surroundings. In the wireless LAN, which is based on sharing of the same frequency among apparatuses, increased interference power reduces communication opportunities for station apparatuses, reducing communication efficiency in unlicensed bands.

An aspect of the present invention has been made in view of the problems described above, and an object of the present invention is to disclose an access point apparatus, a station apparatus, and a communication method that improve communication efficiency in unlicensed bands in a communication system in which the access point apparatus manages direct communication between station apparatuses.

### Solution to Problem

An access point apparatus, a station apparatus, and a communication method according to an aspect of the present invention for solving the aforementioned problems are as follows.

(1) Specifically, an access point apparatus according to an aspect of the present invention is an access point apparatus for communicating with multiple station apparatuses and includes a transmitter that transmits a trigger frame triggering frame transmission performed by each of the multiple station apparatuses, and a receiver that performs carrier sense to reserve multiple radio resources in time periods with different lengths. The trigger frame includes information indicating the time periods for the multiple radio resources reserved by the receiver.

(2) In the access point apparatus according to an aspect of the present invention described in (1) above, the trigger frame may configure first communication that is communication between the multiple station apparatuses and second communication that is communication between the access point apparatus and the multiple station apparatuses, and the trigger frame may include information associated with transmit power for a frame where the first communication is configured.

(3) In the access point apparatus according to an aspect of the present invention described in (2) above, the information described in the trigger frame and indicating the time periods may trigger configuration of NAVs with different attributes for the station apparatus having received the trigger frame.

(4) In the access point apparatus according to an aspect of the present invention described in (3) above, an attribute of a NAV triggered by the trigger frame may be a NAV that is allowed to be updated by a station apparatus where the first communication is configured.

(5) A communication method according to an aspect of the present invention is a communication method for an access point apparatus communicating with multiple station apparatuses and includes the steps of transmitting a trigger frame triggering frame transmission performed by each of the multiple station apparatuses, and performing carrier sense to reserve multiple radio resources in time periods with different lengths. The trigger frame includes information indicating the time periods for the multiple radio resources reserved by the receiver.

### Advantageous Effects of Invention

According to an aspect of the present invention, communication efficiency in unlicensed bands can be improved in a communication system in which an access point apparatus manages direct communication between station apparatuses. This enables contribution to improving user throughput of wireless LAN devices.

### BRIEF DESCRIPTION OF DRAWINGS

FIG. 1 is a diagram illustrating an example of a frame configuration according to an aspect of the present invention.

FIG. 2 is a diagram illustrating an example of a frame configuration according to an aspect of the present invention.

FIG. 3 is a diagram illustrating an example of communication according to an aspect of the present invention.

FIG. 4 is an overview diagram illustrating examples of splitting a radio medium according to an aspect of the present invention.

FIG. 5 is a diagram illustrating a configuration example of a communication system according to an aspect of the present invention.

FIG. 6 is a block diagram illustrating a configuration example of a radio communication apparatus according to an aspect of the present invention.

FIG. 7 is a block diagram illustrating a configuration example of a radio communication apparatus according to an aspect of the present invention.

FIG. 8 is a diagram illustrating an example of communication according to an aspect of the present invention.

FIG. 9 is a diagram illustrating an example of communication according to an aspect of the present invention.

### DESCRIPTION OF EMBODIMENTS

A communication system according to the present embodiment includes a radio transmission apparatus (an access point apparatus, an Access point, and a base station apparatus) and multiple radio reception apparatuses (station apparatuses, stations, and terminal apparatuses). A network including the base station apparatus and terminal apparatuses is called a Basic service set (BSS or a control range). In addition, the station apparatus according to the present embodiment can have functions of the access point apparatus. Similarly, the access point apparatus according to the present embodiment can have functions of the station apparatus. Therefore, in a case that a communication apparatus is simply mentioned below, the communication apparatus can indicate both the station apparatus and the access point apparatus.

The base station apparatus and the terminal apparatuses in the BSS are assumed to perform communication based on Carrier sense multiple access with collision avoidance (CSMA/CA). Although the present embodiment is intended for an infrastructure mode in which a base station apparatus performs communication with multiple terminal apparatuses, the method of the present embodiment can also be performed in an ad hoc mode in which terminal apparatuses perform communication directly with each other. In the ad hoc mode, a terminal apparatus substitutes for a base station apparatus to form a BSS. The BSS in the ad hoc mode may also be referred to as an Independent Basic Service Set (IBSS). In the following description, a terminal apparatus that forms an IBSS in the ad hoc mode can also be considered to be a base station apparatus.

In an IEEE 802.11 system, each apparatus can transmit transmission frames of multiple frame types in a common frame format. The transmission frame is defined in each of the physical (PHY) layer, the Medium access control (MAC) layer, and the Logical Link Control (LLC) layer.

A transmission frame of the PHY layer may be referred to as a physical protocol data unit (PHY protocol data unit (PPDU), or physical layer frame). The PPDU includes a physical layer header (PHY header) including header information and the like for performing signal processing in the physical layer, a physical service data unit (PHY service data unit (PSDU), or MAC layer frame) that is a data unit processed in the physical layer, and the like. The PSDU can include an Aggregated MAC protocol data unit (MPDU) (A-MPDU) in which multiple MPDUs serving as retransmission units in a radio section are aggregated.

The PPDU is modulated in accordance with the corresponding standard. In the IEEE 802.11n standard, for example, the PPDU is modulated into an Orthogonal frequency division multiplexing (OFDM) signal.

A PHY header includes a reference signal such as a Short training field (STF) used for detection, synchronization, and the like of signals, a Long training field (LTF) used for obtaining channel information for demodulating data, and the like and a control signal such as a Signal (SIG) including control information for demodulating data. In addition, STFs are classified into a Legacy-STF (L-STF), a High throughput-STF (HT-STF), a Very high throughput-STF (VHT-STF), a High efficiency-STF (HE-STF), an Extremely High Throughput-STF (EHT-STF), and the like in accordance with corresponding standards, and LTFs and SIGs are also similarly classified into an L-LTF, an HT-LTF, a VHT-LTF, an HE-LTF, an L-SIG, an HT-SIG, a VHT-SIG, an HE-SIG, and an EHT-SIG depending on the corresponding standards. The VHT-SIG is further classified into VHT-SIG-A1, VHT-SIG-A2, and VHT-SIG-B. Similarly, the HE-SIG is classified into HE-SIG-A1 to 4 and HE-SIG-B. In addition, on the assumption of technology update in the same standard, a Universal SIGNAL (U-SIG) field including additional control information can be included.

The SIG can include, as information for demodulating received frames, information indicating a modulation scheme and a coding rate (MCS), the number of spatial data multiplexes (the number of layers), the number of spatial multiplexing users, information indicating the presence or absence of time-space coding (e.g., information indicating the presence or absence of time-space coding transmission diversity), information indicating the destination of the frame, information associated with a frame length of the frame (TXOP, and the like), and the like.

Furthermore, the PHY header can include information for identifying a BSS of a transmission source of the transmission frame (hereinafter, also referred to as BSS identification information). The information for identifying a BSS can be, for example, a Service Set Identifier (SSID) of the BSS or a MAC address of a base station apparatus of the BSS. In addition, the information for identifying a BSS can be a value unique to the BSS (e.g., a BSS Color, and the like) other than an SSID or a MAC address.

Further, since the PHY header including a SIG includes information necessary for data demodulation, it is desirable to have resistance to radio error. Furthermore, it is desirable that the PHY header be correctly received by a wireless LAN apparatus other than a wireless LAN apparatus serving as the destination. Based on the fact that there is a wireless LAN apparatus with a poor communication environment, it is desirable to configure a modulation scheme and coding rate with high redundancy for a PHY header, particularly, a SIG. For example, a communication apparatus can configure a modulation scheme with a low modulation order such as BPSK modulation or a low coding rate in the PHY header.

An MPDU includes a MAC layer header (MAC header) including header information and the like for performing signal processing in the MAC layer, a MAC service data unit (MSDU) or a frame body that is a data unit processed in the MAC layer, and a Frame check sequence (FCS) for checking whether there is an error in a frame. In addition, multiple MSDUs can be aggregated as an Aggregated MSDU (A-MSDU).

Frame types of a transmission frame of the MAC layer are generally classified into three frame types, namely a management frame for managing a connection state and the like between apparatuses, a control frame for managing a communication state between apparatuses, and a data frame including actual transmission data, and each frame type is further classified into multiple types of subframes. The control frame includes a reception completion notification (Acknowledge or Ack) frame, a transmission request (Request to send or RTS) frame, a reception preparation completion (Clear to send or CTS) frame, and the like. The management frame includes a Beacon frame, a Probe request frame, a Probe response frame, an Authentication frame, an Association request frame, an Association response frame, and the like. The data frame includes a Data frame, a polling (CF-poll) frame, and the like. Each apparatus can recognize the frame type and the subframe type of a received frame by interpreting contents of the frame control field included in the MAC header.

Note that an Ack may include a Block Ack. A Block Ack can give a reception completion notification with respect to multiple MPDUs.

The beacon frame includes a Field in which a periodicity at which a beacon is transmitted (Beacon interval) and an SSID are described. The base station apparatus can periodically broadcast a beacon frame within a BSS, and each terminal apparatus can recognize the base station apparatus in the surroundings of the terminal apparatus by receiving the beacon frame. The action of the terminal apparatus recognizing the base station apparatus based on the beacon frame broadcast from the base station apparatus may be referred to as Passive scanning. On the other hand, the action of the terminal apparatus searching for the base station apparatus by broadcasting a probe request frame in the BSS may be referred to as Active scanning. The base station apparatus can transmit a probe response frame in response to the probe request frame, and details described in the probe response frame are equivalent to those in the beacon frame.

A terminal apparatus recognizes a base station apparatus and performs association processing with respect to the base station apparatus. The association processing is classified into an Authentication procedure and an Association procedure. A terminal apparatus transmits an authentication frame (authentication request) to a base station apparatus that the terminal apparatus desires to associate with. Once the base station apparatus receives the authentication frame, then the base station apparatus transmits, to the terminal apparatus, an authentication frame (authentication response) including a status code indicating whether authentication can be made for the terminal apparatus. The terminal apparatus can determine whether the terminal apparatus has been authenticated by the base station apparatus by interpreting the status code described in the authentication frame. Note that the base station apparatus and the terminal apparatus can exchange the authentication frame multiple times.

After the authentication procedure, the terminal apparatus transmits an association request frame to the base station apparatus in order to perform the association procedure. Once the base station apparatus receives the association request frame, the base station apparatus determines whether to allow association of the terminal apparatus and transmits an association response frame to notify the terminal apparatus of the intent. In the association response frame, an Association identifier (AID) for identifying the terminal apparatus is described in addition to the status code indicating whether to perform the association processing. The base station apparatus can manage multiple terminal apparatuses by configuring different AIDs for the terminal apparatuses for which the base station apparatus has allowed association.

After the association processing is performed, the base station apparatus and the terminal apparatus perform actual data transmission. In the IEEE 802.11 system, a Distributed Coordination Function (DCF), a Point Coordination Function (PCF), and mechanisms in which the aforementioned mechanisms are enhanced (an Enhanced distributed channel access (EDCA) or a hybrid control mechanism (Hybrid coordination function (HCF)), and the like) are defined. A case that the base station apparatus transmits signals to the terminal apparatus using the DCF will be described below as an example.

In the DCF, the base station apparatus and the terminal apparatus perform Carrier sense (CS) for checking usage of a radio channel in the surroundings of the apparatuses prior to communication. For example, in a case that the base station apparatus serving as a transmitting station receives a signal of a higher level than a predefined Clear channel assessment level (CCA level) on a radio channel, transmission of transmission frames on the radio channel is postponed. Hereinafter, a state in which a signal of a level that is equal to or higher than the CCA level is detected on the radio channel will be referred to as a busy (Busy) state, and a state in which a signal of a level that is equal to or higher than the CCA level is not detected will be referred to as an idle (Idle) state. In this manner, CS performed based on power of a signal actually received by each apparatus (reception power level) is called physical carrier sense (physical CS). Note that the CCA level is also called a carrier sense level (CS level) or a CCA threshold (CCAT). Note that, in a case that a signal of a level that is equal to or higher than the CCA level has been detected, the base station apparatus and the terminal apparatus start to perform an operation of demodulating at least a signal of the PHY layer.

Further, a simple description of carrier sense below includes a case that virtual carrier sense to be described below is performed. In addition, a simple description of carrier sense level below includes a case that it indicates a minimum reception sensitivity indicating a received signal power at which a communication apparatus demodulates at least a signal of the PHY layer. That is, in a case that a received signal power of a frame as a received signal power equal to or greater than the minimum reception sensitivity is observed in receiving the frame, the communication apparatus needs to demodulate at least a signal of the PHY layer for the frame. In the case that the communication apparatus observes a received signal power lower than or equal to the minimum reception sensitivity, the communication apparatus is able to plan to perform frame transmission, without having to demodulate the frame. Thus, it can be said that a carrier sense level and the minimum reception sensitivity have the same meaning.

The base station apparatus performs carrier sense in an Inter frame space (IFS) in accordance with the type of transmission frame to be transmitted and determines whether the radio channel is in a busy state or idle state. A period in which the base station apparatus performs carrier sense varies depending on the frame type and the subframe type of a transmission frame to be transmitted by the base station apparatus. In the IEEE 802.11 system, multiple IFSs with different periods are defined, and there are a short frame interval (Short IFS or SIFS) used for a transmission frame with the highest priority given, a polling frame interval (PCF IFS or PIFS) used for a transmission frame with a relatively high priority, a distribution control frame interval (DCF IFS or DIFS) used for a transmission frame with the lowest priority, and the like. In a case that the base station apparatus transmits a data frame with the DCF, the base station apparatus uses the DIFS.

The base station apparatus waits by DIFS and then further waits for a random backoff time to prevent frame collision. In the IEEE 802.11 system, a random backoff time called a Contention window (CW) is used. CSMA/CA works with the assumption that a transmission frame transmitted by a certain transmitting station is received by a receiving station in a state in which there is no interference from other transmitting stations. Therefore, in a case that transmitting stations transmit transmission frames at the same timing, the frames collide against each other, and the receiving station cannot receive them properly. Thus, each transmitting station waits for a randomly configured time before starting transmission, and thus collision of frames can be avoided. In a case that the base station apparatus determines, through carrier sense, that a radio channel is in the idle state, the base station apparatus starts to count down a CW, acquires a transmission right for the first time after the CW becomes zero, and can transmit a transmission frame to the terminal apparatus. Note that, in a case that the base station apparatus determines through the carrier sense that the radio channel is in the busy state during the count-down of the CW, the base station apparatus stops the count-down of the CW. Thereafter, in a case that the radio channel becomes in the idle state, then the base station apparatus restarts the count-down of the remaining CW after the previous IFS.

A terminal apparatus that is a receiving station receives a transmission frame, interprets the PHY header of the transmission frame, and demodulates the received transmission frame. Then, the terminal apparatus interprets the MAC header of the demodulated signal and thus can recognize whether the transmission frame is addressed to the terminal apparatus itself. Note that the terminal apparatus can also determine the destination of the transmission frame based on information described in the PHY header (for example, a Group identifier (Group ID or GID) described in VHT-SIG-A).

In a case that the terminal apparatus determines that the received transmission frame is addressed to the terminal apparatus and successfully demodulates the transmission frame without any error, the terminal apparatus is to transmit an ACK frame indicating the proper reception of the frame to the base station apparatus that is the transmitting station. The ACK frame is one of transmission frames with the highest priority transmitted only after a wait for the SIFS period (with no random backoff time). The base station apparatus ends the series of communication with the reception of the ACK frame transmitted from the terminal apparatus. Note that, in a case that the terminal apparatus is not able to receive the frame properly, the terminal apparatus does not transmit ACK. Thus, in a case that the ACK frame has not been received from the receiving station for a certain period (a length of SIFS+ACK frame) after the transmission of the frame, the base station apparatus considers the communication to be failed and ends the communication. In this manner, an end of a single communication operation (also called a burst) in the IEEE 802.11 system is to be determined based on whether an ACK frame is received, except for special cases such as a case of transmission of a broadcast signal such as a beacon frame, a case that fragmentation for splitting transmission data is used, or the like.

In a case that the terminal apparatus determines that the received transmission frame is not addressed to the terminal apparatus itself, the terminal apparatus configures a Network allocation vector (NAV) based on the Length of the transmission frame described in the PHY header or the like. The terminal apparatus does not attempt communication during the period configured in the NAV. In other words, because the terminal apparatus performs the same operation as in the case that the terminal apparatus determines the radio channel is in the busy state through physical CS for the period configured in the NAV, the communication control based on the NAV is also called virtual carrier sense (virtual CS). The NAV is also configured by a transmission request (Request to send or RTS) frame or a reception preparation completion (Clear to send or CTS) frame, which are introduced to solve a hidden terminal problem in addition to the case that the NAV is configured based on the information described in the PHY header.

Unlike the DCF in which each apparatus performs carrier sense and autonomously acquires the transmission right, with respect to the PCF, a control station called a Point coordinator (PC) controls the transmission right of each apparatus within a BSS. In general, a base station apparatus serves as a PC and acquires the transmission right of a terminal apparatus within a BSS.

A communication period using the PCF includes a Contention free period (CFP) and a Contention period (CP). Communication is performed based on the aforementioned DCF during a CP, and a PC controls the transmission right during a CFP. The base station apparatus serving as a PC broadcasts a beacon frame with description of a CFP period (CFP Max duration) and the like in a BSS prior to communication with a PCF. Note that the PIFS is used for transmission of the beacon frame broadcast at the time of a start of transmission by the PCF, and the beacon frame is transmitted without waiting for the CW. The terminal apparatus that has received the beacon frame configures the CFP period described in the beacon frame in a NAV. Hereinafter, the terminal apparatus can acquire the transmission right only in a case that a signal (e.g., a data frame including CF-poll) for signaling the acquisition of the transmission right transmitted by the PC is received, until the NAV elapses or a signal (e.g., a data frame including CF-end) broadcasting the end of the CFP in the BSS is received. Note that, because no packet collision occurs in the same BSS during the CFP period, each terminal apparatus does not take a random backoff time used for the DCF.

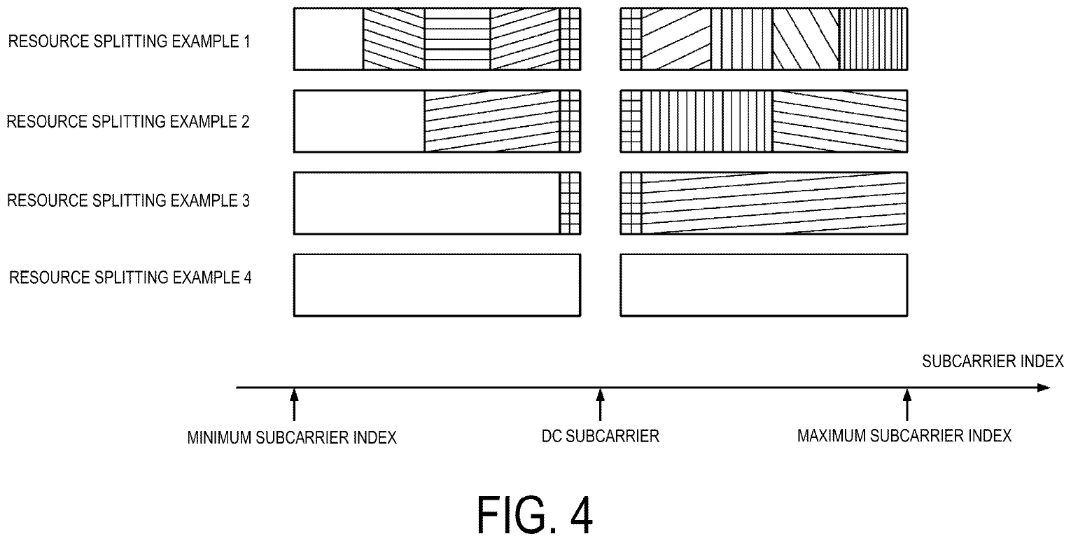

A radio medium can be split into multiple Resource units (RUS). FIG. 4 is an overview diagram illustrating an example of a split state of a radio medium. In a resource splitting example 1, for example, a radio communication apparatus can a split frequency resources (subcarrier, frequency tone, and tone) that is a radio medium into nine RUs. Similarly, in the resource splitting example 2, the radio communication apparatus can split a subcarrier that is a radio medium into five RUs. It is a matter of course that the resource splitting examples illustrated in FIG. 4 are merely examples, and for example, the multiple RUs can include a different number of subcarriers. The radio medium that is split into RUs can include not only a frequency resource but also a spatial resource. The radio communication apparatus (e.g., an AP) can transmit frames to multiple terminal apparatuses (e.g., multiple STAs) at the same time by mapping frames addressed to different terminal apparatuses to the respective RUs. An AP can describe information indicating a split state of the radio medium (Resource allocation information) as common control information in the PHY header of the frame transmitted by the AP itself. Moreover, the AP can describe information indicating an RU to which a frame addressed to each STA is mapped (resource unit assignment information) as unique control information in the PHY header of the frame transmitted by the AP itself.

Multiple terminal apparatuses (e.g., multiple STAs) can transmit frames at the same time by mapping and transmitting the frames to and in the respective RUs allocated to themselves. The multiple STAs can perform frame transmission after waiting for a prescribed period after receiving the frame including trigger information transmitted from the AP (Trigger frame or TF). Each STA can recognize the RU allocated to the STA itself based on the information described in the TF. Each STA can acquire the RU through random access with reference to the TF.

The AP can allocate multiple RUs to one STA at the same time. The multiple RUs can include continuous subcarriers or can include discontinuous subcarriers. The AP can transmit one frame using multiple RUs allocated to one STA or can transmit multiple frames after allocating them to different RUs. At least one of the multiple frames can be a frame including common control information for multiple terminal apparatuses that transmit resource allocation information.

One STA can be allocated multiple RUs by the AP. The STA can transmit one frame using the multiple allocated RUs. Also, the STA can use the multiple allocated RUs to transmit multiple frames allocated to different RUs. The multiple frames each can be a frame of a different frame type.

The AP can allocate multiple Association IDs (AIDs) to one STA. The AP can allocate an RU to each of the multiple AIDs allocated to the one STA. The AP can transmit different frames using the respective RUs allocated to the multiple AIDs allocated to the one STA. The different frames each can be a frame of a different frame type.

One STA can be allocated multiple Associate IDs (AIDs) by the AP. The one STA can be allocated an RU with respect to each of the multiple allocated AIDs. The one STA recognizes all of the RUs allocated to the respective multiple AIDs allocated to the STA itself as RUs allocated to the STA and can transmit one frame using the multiple allocated RUs. In addition, the one STA can transmit multiple frames using the multiple allocated RUs. At this time, the multiple frames can be transmitted with information indicating the AIDs associated with the respective allocated RUs described therein. The AP can transmit different frames using the respective RUs allocated to the multiple AIDs allocated to the one STA. The different frames can be frames of different frame types.

Hereinafter, the base station apparatus and the terminal apparatuses may be collectively referred to as radio communication apparatuses or communication apparatuses. Information exchanged in a case that a certain radio communication apparatus performs communication with another radio communication apparatus may also be referred to as data. In other words, radio communication apparatuses include a base station apparatus and a terminal apparatus.

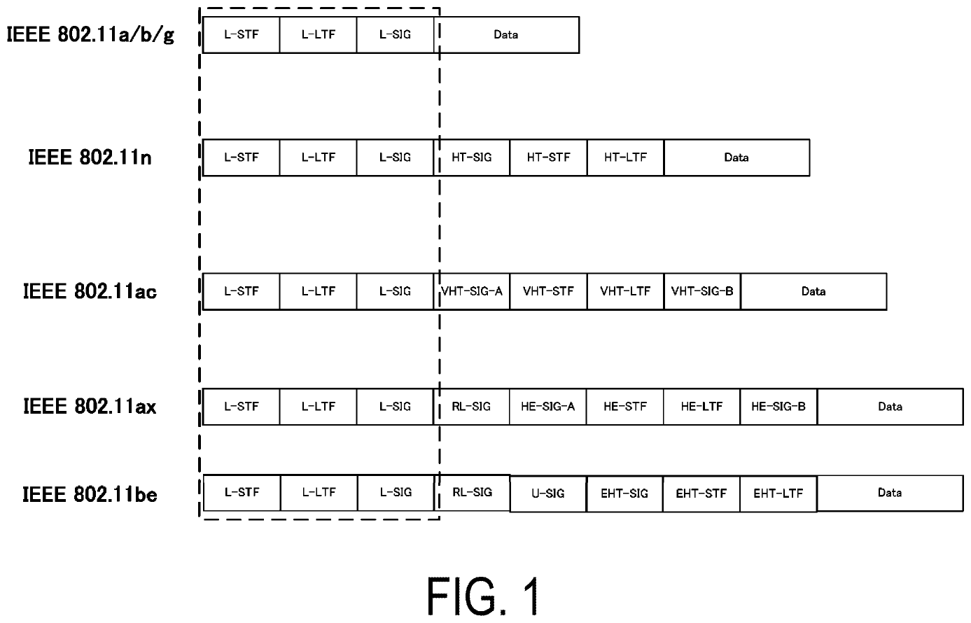

A radio communication apparatus includes any one of or both the function of transmitting a PPDU and a function of receiving a PPDU. FIG. 1 is a diagram illustrating examples of configurations of a PPDU transmitted by a radio communication apparatus. A PPDU that is compliant with the IEEE 802.11a/b/g standard includes L-STF, L-LTF, L-SIG, and a Data frame (a MAC Frame, a MAC frame, a payload, a data part, data, information bits, and the like). A PPDU that is compliant with the IEEE 802.11n standard includes L-STF, L-LTF, L-SIG, HT-SIG, HT-STF, HT-LTF, and a Data frame. A PPDU that is compliant with the IEEE 802.11ac standard includes some or all of L-STF, L-LTF, L-SIG, VHT-SIG-A, VHT-STF, VHT-LTF, VHT-SIG-B, and a MAC frame. A PPDU studied in the IEEE 802.11ax standard includes some or all of L-STF, L-LTF, L-SIG, RL-SIG in which L-SIG is temporally repeated, HE-SIG-A, HE-STF, HE-LTF, HE-SIG-B, and a Data frame. A PPDU studied in the IEEE 802.11be standard includes some or all of L-STF, L-LTF, L-SIG, RL-SIG, U-SIG, EHT-SIG, EHT-STF, HET-LTF, and a Data frame.

L-STF, L-LTF, and L-SIG surrounded by the dotted line in FIG. 1 are configurations commonly used in the IEEE 802.11 standard (hereinafter, L-STF, L-LTF, and L-SIG may also be collectively referred to as an L-header). For example, a radio communication apparatus that is compliant with the IEEE 802.11a/b/g standard can appropriately receive an L-header in a PPDU that is compliant with the IEEE 802.11n/ac standard. A radio communication apparatus that is compliant with the IEEE 802.11a/b/g standard can receive the PPDU that is compliant with the IEEE 802.11n/ac standard while considering it to be a PPDU that is compliant with the IEEE 802.11a/b/g standard.

However, because the radio communication apparatus that is compliant with the IEEE 802.11a/b/g standard cannot demodulate the PPDU that is compliant with the IEEE 802.11n/ac standard following the L-header, it is not possible to demodulate information about a Transmitter Address (TA), a Receiver Address (RA), and a Duration/ID field used for configuring a NAV.

As a method for the radio communication apparatus that is compliant with the IEEE 802.11a/b/g standard to appropriately configure a NAV (or to perform a receiving operation for a prescribed period), IEEE 802.11 defines a method of inserting Duration information to the L-SIG. Information about a transmission speed in the L-SIG (a RATE field, an L-RATE field, an L-RATE, an L_DATARATE, and an L_DATARATE field) and information about a transmission period (a LENGTH field, an L-LENGTH field, and an L-LENGTH) are used by the radio communication apparatus that is compliant with the IEEE 802.11a/b/g standard to appropriately configure a NAV.

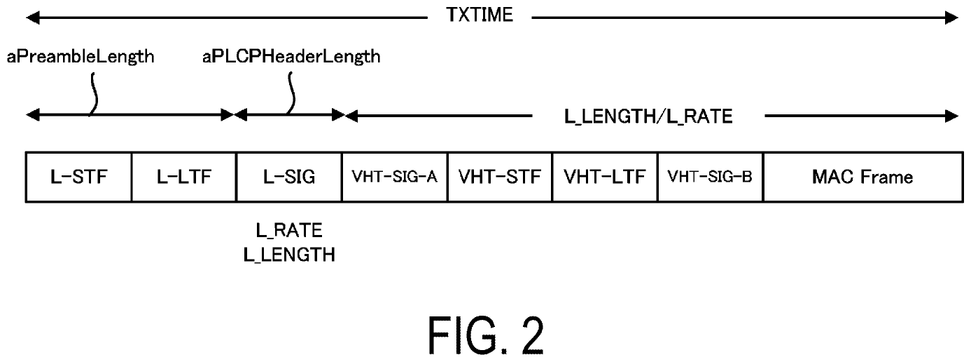

FIG. 2 is a diagram illustrating an example of a method for Duration information inserted into an L-SIG. Although a PPDU configuration that is compliant with the IEEE 802.11ac standard is illustrated as an example in FIG. 2, a PPDU configuration is not limited thereto. A PPDU configuration that is compliant with the IEEE 802.11n standard and a PPDU configuration that is compliant with the IEEE 802.11ax standard may be employed. TXTIME includes information about a length of a PPDU, aPreambleLength includes information about a length of a preamble (L-STF+L-LTF), and aPLCPHeaderLength includes information about a length of a PLCP header (L-SIG). L_LENGTH is calculated based on Signal Extension that is a virtual period configured for compatibility with the IEEE 802.11 standard, Nops related to L-RATE, aSymbolLength that is information about a period of one symbol (a symbol, an OFDM symbol, or the like), aPLCPServiceLength indicating the number of bits included in PLCP Service field, and aPLCPConvolutionalTailLength indicating the number of tail bits of a convolution code. The radio communication apparatus can calculate L_LENGTH and insert L_LENGTH into L-SIG. The radio communication apparatus can calculate L-SIG Duration. L-SIG Duration indicates information about a PPDU including L_LENGTH and information about a period that is the sum of periods of Ack and SIFS expected to be transmitted by the destination radio communication apparatus in response to the PPDU.

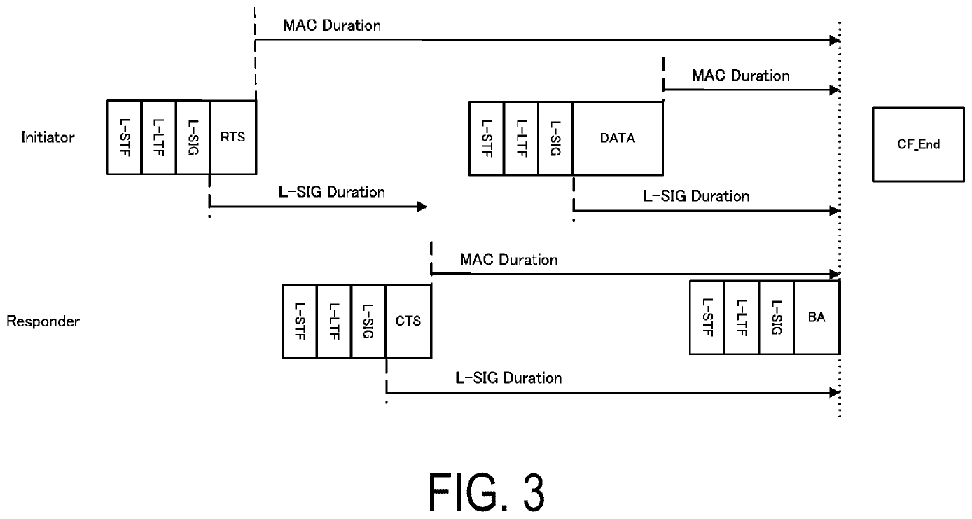

FIG. 3 is a diagram illustrating an example of L-SIG Duration in L-SIG TXOP Protection. DATA (a frame, a payload, data, and the like) include some of or both the MAC frame and the PLCP header. BA includes Block Ack or Ack. A PPDU includes L-STF, L-LTF, and L-SIG and can further include any one or more of DATA, BA, RTS, or CTS. Although L-SIG TXOP Protection using RTS/CTS is illustrated in the example illustrated in FIG. 3, CTS-to-Self may be used. Here, MAC Duration is a period indicated by a value of Duration/ID field. Initiator can transmit a CF_End frame for providing a notification regarding an end of the L-SIG TXOP Protection period.

Next, a method of identifying a BSS from a frame received by a radio communication apparatus will be described. In order for a radio communication apparatus to identify a BSS from a received frame, the radio communication apparatus that transmits a PPDU preferably inserts information for identifying the BSS (BSS color, BSS identification information, or a value unique to the BSS) into the PPDU. The information indicating the BSS color can be described in HE-SIG-A.

The radio communication apparatus can transmit L-SIG multiple times (L-SIG Repetition). For example, demodulation accuracy of L-SIG is improved by the radio communication apparatus on the reception side receiving L-SIG transmitted multiple times by using Maximum Ratio Combining (MRC). Moreover, in a case that reception of L-SIG is properly completed using MRC, the radio communication apparatus can interpret the PPDU including the L-SIG as a PPDU that is compliant with the IEEE 802.11ax standard.

Even during the operation of receiving the PPDU, the radio communication apparatus can perform a reception operation of a PPDU other than the corresponding PPDU (e.g., the preamble, L-STF, L-LTF, and the PLCP header prescribed by IEEE 802.11) (also referred to as a double-reception operation). In a case that a part of a PPDU other than the PPDU is detected during the operation of receiving the PPDU, the radio communication apparatus can update a part or an entirety of information about a destination address, a transmission source address, a PPDU, or a DATA period.

An Ack and a BA can also be referred to as a response (response frame). A probe response, an authentication response, and an association response can also be referred to as a response.

### 1. First Embodiment

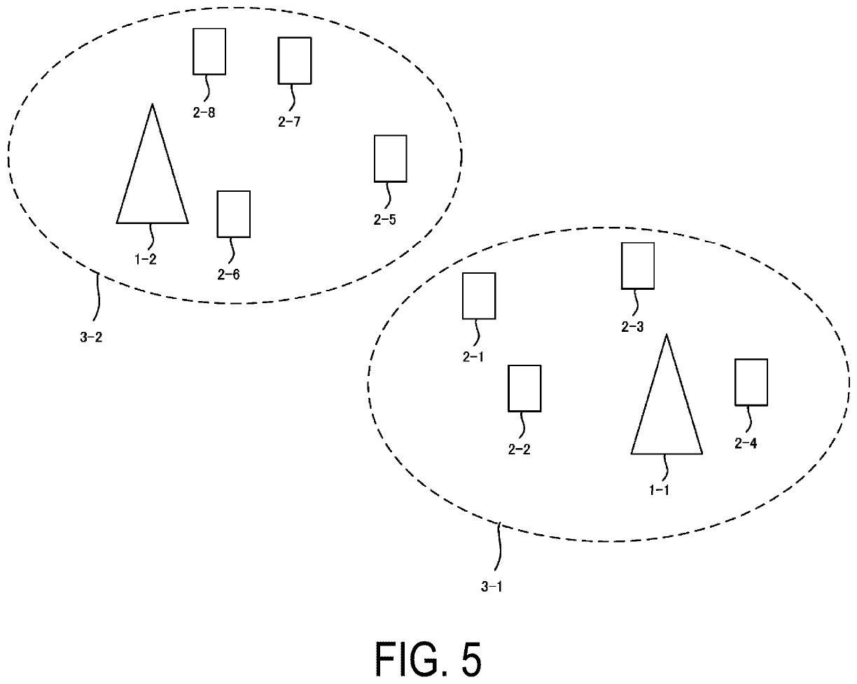

FIG. 5 is a diagram illustrating an example of a radio communication system according to the present embodiment. A radio communication system 3-1 includes a radio communication apparatus 1-1 and radio communication apparatuses 2-1 to 2-4. Note that the radio communication apparatus 1-1 will also be referred to as a base station apparatus 1-1 or an access point apparatus 1-1, and the radio communication apparatuses 2-1 to 2-4 will also be referred to as terminal apparatuses 2-1 to 2-4 or station apparatuses 2-1 to 2-4. In addition, the radio communication apparatuses 2-1 to 2-4 and the terminal apparatuses 2-1 to 2-4 will also be referred to as a radio communication apparatus 2A and a terminal apparatus 2A, respectively, as apparatuses associated with the radio communication apparatus 1-1. The radio communication apparatus 1-1 and the radio communication apparatus 2A are wirelessly associated with each other and are in a state in which they can transmit and/or receive PPDUs to and from each other. In addition, the radio communication system according to the present embodiment includes a radio communication system 3-2 in addition to the radio communication system 3-1. The radio communication system 3-2 includes a radio communication apparatus 1-2 and radio communication apparatuses 2-5 to 2-8. Further, the radio communication apparatus 1-2 will also be referred to as a base station apparatus 1-2 and the radio communication apparatuses 2-5 to 2-8 will also be referred to as terminal apparatuses 2-5 to 2-8. In addition, the radio communication apparatuses 2-5 to 2-8 and terminal apparatuses 2-5 to 2-8 will also be referred to as a radio communication apparatus 2B and a terminal apparatus 2B, respectively, as apparatuses associated with the radio communication apparatus 1-2. Although the radio communication system 3-1 and the radio communication system 3-2 form different BSSs, this does not necessarily mean that Extended Service Sets (ESSs) are different. An ESS indicates a service set forming a Local Area Network (LAN). In other words, radio communication apparatuses belonging to the same ESS can be regarded as belonging to the same network from a higher layer. Further, the radio communication systems 3-1 and 3-2 can further include multiple radio communication apparatuses.

In the description below, among the station apparatuses associated with the access point apparatus 1-1, the station apparatus 2-1 and the station apparatus 2-2 are assumed to communicate directly with each other. Note that the station apparatus 2-3 and the station apparatus 2-4 can also communicate directly with each other.

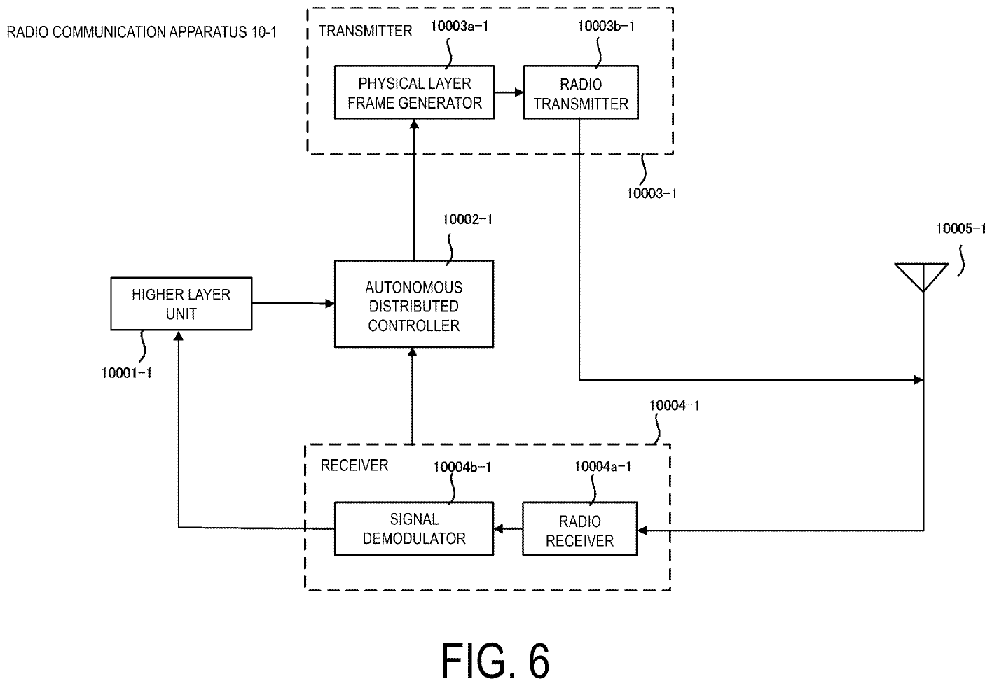

FIG. 6 is a diagram illustrating an example of an apparatus configuration of the radio communication apparatuses 1-1, 1-2, 2A, and 2B (hereinafter, collectively referred to as a radio communication apparatus 10-1 or a station apparatus 10-1 or also simply referred to as a station apparatus). The radio communication apparatus 10-1 includes a higher layer unit (higher layer processing step) 10001-1, an autonomous distributed controller (autonomous distributed control step) 10002-1, a transmitter (transmission step) 10003-1, a receiver (reception step) 10004-1, and an antenna unit 10005-1.

The higher layer unit 10001-1 is connected to another network and can notify the autonomous distributed controller 10002-1 of information about traffic. The information about traffic may be, for example, information addressed to other radio communication apparatuses, or may be control information included in a management frame or a control frame.

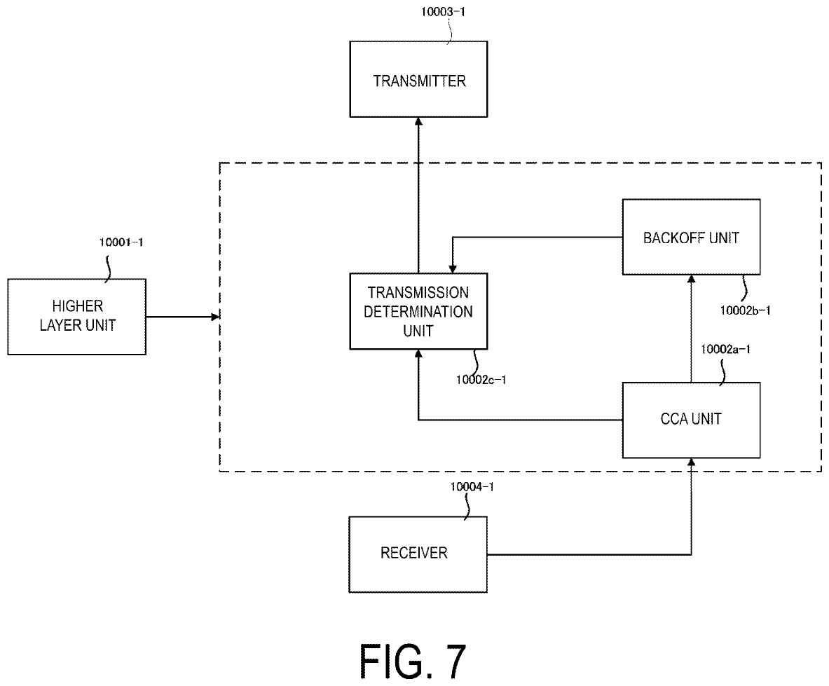

FIG. 7 is a diagram illustrating an example of an apparatus configuration of the autonomous distributed controller 10002-1. The autonomous distributed controller 10002-1 includes a CCA unit (CCA step) 10002a-1, a backoff unit (backoff step) 10002b-1, and a transmission determination unit (transmission determination step) 10002c-1.

The CCA unit 10002a-1 can use either of or both of information about received signal power received via radio resources and information about the reception signal (including information after decoding), the notification of which are provided from the receiver, to determine a state of the radio resources (including determining whether the state is busy or idle). The CCA unit 10002a-1 can notify the backoff unit 10002b-1 and the transmission determination unit 10002c-1 of the state determination information of the radio resources.

The backoff unit 10002b-1 can perform backoff using the state determination information of the radio resources. The backoff unit 10002b-1 has a function of generating a CW and counting down the CW. For example, the count-down of the CW is performed in a case that the state determination information of the radio resources indicates idle, and the count-down of the CW can be stopped in a case that the state determination information of the radio resources indicates busy. The backoff unit 10002b-1 can notify the transmission determination unit 10002c-1 of the value of the CW.

The transmission determination unit 10002c-1 performs transmission determination using either of or both the state determination information of the radio resources or/and the value of the CW. For example, the notification of transmission determination information can be provided to the transmitter 10003-1 in a case that the state determination information of the radio resources indicates idle and the value of the CW is zero. The notification of the transmission determination information can be provided to the transmitter 10003-1 in a case that the state determination information of the radio resources indicates idle.

The transmitter 10003-1 includes a physical layer frame generator (physical layer frame generation step) 10003a-1 and a radio transmitter (radio transmission step) 10003b-1. The physical layer frame generator 10003a-1 has a function of generating a physical layer frame (PPDU) based on the transmission determination information, the notification of which is provided from the transmission determination unit 10002c-1. The physical layer frame generator 10003a-1 performs error correction coding, modulation, precoding filter multiplication, and the like on transmission frames sent from the higher layer. The physical layer frame generator 10003a-1 notifies the radio transmitter 10003b-1 of the generated physical layer frame.

The frame generated by the physical layer frame generator 10003a-1 includes control information. The control information includes information indicating to which RU the data addressed to each radio communication apparatus is mapped (here, the RU including both frequency resources and spatial resources). The frame generated by the physical layer frame generator 10003a-1 includes a trigger frame for indicating, to the radio communication apparatus that is a destination terminal, frame transmission. The trigger frame includes information indicating the RU to be used by the radio communication apparatus that has received the indication for the frame transmission to transmit the frame.

The radio transmitter 10003b-1 converts the physical layer frame generated by the physical layer frame generator 10003a-1 into a signal in a Radio Frequency (RF) band to generate a radio frequency signal. Processing performed by the radio transmitter 10003b-1 includes digital-to-analog conversion, filtering, frequency conversion from a baseband to an RF band, and the like.

The receiver 10004-1 includes a radio receiver (radio reception step) 10004a-1 and a signal demodulator (signal demodulation step) 10004b-1. The receiver 10004-1 generates information about received signal power from a signal in the RF band received by the antenna unit 10005-1. The receiver 10004-1 can notify the CCA unit 10002a-1 of the information about the received signal power and the information about the reception signal.

The radio receiver 10004a-1 has a function of converting a signal in the RF band received by the antenna unit 10005-1 into a baseband signal and generating a physical layer signal (e.g., a physical layer frame). Processing performed by the radio receiver 10004a-1 includes frequency conversion processing from the RF band to the baseband, filtering, and analog-to-digital conversion.

The signal demodulator 10004b-1 has a function of demodulating a physical layer signal generated by the radio receiver 10004a-1. Processing performed by the signal demodulator 10004b-1 includes channel equalization, demapping, error correction decoding, and the like. The signal demodulator 10004b-1 can extract, from the physical layer signal, information included in the physical layer header, information included in the MAC header, and information included in the transmission frame, for example. The signal demodulator 10004b-1 can notify the higher layer unit 10001-1 of the extracted information. Note that the signal demodulator 10004b-1 can extract any one or all of the information included in the physical layer header, the information included in the MAC header, and the information included in the transmission frame.

The antenna unit 10005-1 has a function of transmitting a radio frequency signal generated by the radio transmitter 10003b-1 into the radio space toward a radio apparatus 0-1. The antenna unit 10005-1 has a function of receiving a radio frequency signal transmitted by the radio apparatus 0-1.

The radio communication apparatus 10-1 can describe, in the PHY header or the MAC header of the frame to be transmitted, information indicating the period in which the apparatus itself uses the radio medium to configure a NAV for the period for a radio communication apparatus around the aforementioned apparatus. For example, the radio communication apparatus 10-1 can describe the information indicating the period in a Duration/ID field or a Length field of the frame to be transmitted. The NAV period configured for the radio communication apparatuses around the radio communication apparatus itself will be referred to as a TXOP period (or simply TXOP) acquired by the radio communication apparatus 10-1. In addition, the radio communication apparatus 10-1 that has acquired the TXOP will be referred to as a TXOP acquirer (TXOP holder). The type of frame to be transmitted by the radio communication apparatus 10-1 to acquire TXOP is not limited to any frame type, and the frame may be a control frame (e.g., an RTS frame or a CTS-to-self frame) or may be a data frame.

The radio communication apparatus 10-1 that is a TXOP holder can transmit the frame to a radio communication apparatus other than the radio communication apparatus itself during the TXOP. In a case that the radio communication apparatus 1-1 is a TXOP holder, the radio communication apparatus 1-1 can transmit a frame to the radio communication apparatus 2A during the TXOP period. The radio communication apparatus 1-1 can indicate, to the radio communication apparatus 2A, a frame transmission addressed to the radio communication apparatus 1-1 during the TXOP period. The radio communication apparatus 1-1 can transmit, to the radio communication apparatus 2A, a trigger frame including information for indicating a frame transmission addressed to the radio communication apparatus 1-1 during the TXOP period.

The radio communication apparatus 1-1 may acquire a TXOP for the entire communication band (e.g., Operation bandwidth) in which frame transmission is likely to be performed, or may acquire a TXOP for a specific communication band (Band) such as a communication band in which frames are actually transmitted (e.g., Transmission bandwidth).

The radio communication apparatus, to which the radio communication apparatus 1-1 indicates a frame transmission in the TXOP period acquired by the radio communication apparatus 1-1, is not necessarily limited to a radio communication apparatus associated with the radio communication apparatus 1-1. For example, the radio communication apparatus can indicate to radio communication apparatuses that are not associated with the radio communication apparatus itself to transmit a frame, in order to cause a radio communication apparatus around the apparatus itself to transmit a management frame such as a Reassociation frame or a control frame such as an RTS/CTS frame.

The access point apparatus 1-1 according to the present embodiment transmits a trigger frame for reserving a TXOP before causing the station apparatus 2-1 and the station apparatus 2-2 to communicate directly with each other (first communication). The trigger frame includes information for triggering frame transmission performed by at least one of the station apparatus 2-1 and the station apparatus 2-2 (or transitioning to a carrier sense operation). The station apparatuses planning to communicate directly with each other can transmit, to the access point apparatus, a frame requesting reservation of radio resources for the direct communication. Hereinafter, communication between the access point apparatus 1-1 and the station apparatus 2-1 and the station apparatus 2-2 is also referred to as second communication.

The trigger frame includes information indicating a radio resource used in a case that the station apparatus 2-1 and the station apparatus 2-2 communicating directly with each other. The trigger frame includes information indicating which of the station apparatus 2-1 and the station apparatus 2-2 is configured as a frame sender or a frame responder.

Prior to receiving the trigger frame describing the information associated with the direct communication radio resource, the access point apparatus can transmit a multi-user RTS frame to the station apparatus that is the destination of the trigger frame. The access point apparatus can transmit the trigger frame only in a case that in response of the CTS frame, the multi-user RTS frame is received. At this time, in a case that the destination of the multi-user RTS frame (or the trigger frame) includes multiple station apparatuses, the access point apparatus can transmit the trigger frame in a case that any response with the CTS frame is received. The access point apparatus can transmit the trigger frame only to the radio resource from which the response with the CTS frame is received.

The access point apparatus can configure the trigger frame with the function of the multi-user RTS frame. In other words, before transmitting the direct communication frame (Direct Link frame), the station apparatus having received the trigger frame can transmit the CTS frame (or any response frame) to the access point apparatus, and then transmit the direct communication frame. For the destination terminals of the direct communication frame, the station apparatus may include, in the destination terminals, the access point apparatus having transmitted the trigger frame, in addition to the original destination station apparatus of the direct communication frame (that is, the destination station apparatus in the data field configured in the direct communication frame). At this time, the station apparatus describes, in the PHY header, information indicating that at least two radio apparatuses correspond to destination terminals. However, the station apparatus does not expect a response (for example, an ACK frame) from the access point apparatus to the direct communication frame. Alternatively, based on a prescribed configuration, the station apparatus expects that a response from the access point apparatus to the direct communication frame and a response from the destination station apparatus occur at the same time.

The trigger frame includes information indicating a radio resource configured for direct communication among radio resources reserved by the trigger frame. Hereinafter, a radio resource configured for direct communication is also referred to as a direct communication radio resource.

Hereinafter, a radio frame communicated by the direct communication radio resource, for example, a radio frame exchanged between the station apparatus 2-1 and the station apparatus 2-2 is also referred to as a direct communication frame. On the other hand, a radio frame exchanged between the station apparatus 2-1 and the access point apparatus 1-1 is simply referred to as a communication frame.

The trigger frame can describe information indicating multiple station apparatuses caused to plan to transmit the direct communication frame. In other words, the access point apparatus according to the present embodiment can cause multiple station apparatuses to transmit a direct communication frame in a direct communication radio resource reserved in a prescribed time period by the access point apparatus.

In a case that the access point apparatus causes the multiple station apparatuses to transmit the direct communication frame in the direct communication radio resource, the access point apparatus can multiplex the multiple station apparatuses by time division multiplexing, frequency division multiplexing, and space division multiplexing. The access point apparatus can include, in the trigger frame, information indicating, to the multiple station apparatuses, a radio resource for transmitting the direct communication frame, together with information indicating whether the station apparatus is a frame sender or a frame responder.

The access point apparatus may configure contention-based communication for the station apparatus in the direct communication radio resource. The access point apparatus can include, in the trigger frame, information indicating that the direct communication radio resource reserved by the access point apparatus is configured for the contention-based communication. The access point apparatus may include, in the trigger frame, information indicating station apparatuses that can participate in the contention-based communication in the direct communication radio resource. In the direct radio resource, a station apparatus that can perform frame transmission in the contention-based communication can reserve the direct communication radio resource by a method common to other station apparatuses (for example, random backoff using a contention window). Note that the access point apparatus can include, in the trigger frame, information (for example, the initial value of the contention window) associated with means for reserving the direct communication radio resource.

Note that the access point apparatus and the station apparatus can configure, in the direct communication radio resource, contention-based communication different from other types of communication. Here, the different contention-based communication includes, for example, a method including a different backoff counter. In other words, the station apparatus according to the present embodiment can include a backoff counter used in a case of transmitting the direct communication frame and which is different from a backoff counter used in a case of transmitting the communication frame.

The access point apparatus can allow contention-based communication and contention-free-based communication to coexist in the direct communication radio resource. For example, the access point apparatus can configure multiple RUs in the direct communication radio resource reserved by the access point apparatus, and configure the contention-free communication in a first RU and the contention-based communication in a second RU. Here, the contention-free communication includes communication pre-configured with a radio resource in which the station apparatus transmits the direct communication frame.

The trigger frame may include the transmit power configured for the direct communication frame transmitted in the direct communication radio resource. Although the value of the transmit power is limited to nothing, the value of transmit power can be configured that is lower than transmit power configured for the frames other than the direct communication frame.

The station apparatus having received the trigger frame can configure the transmit power based on the transmit power information included in the trigger frame and transmit the direct communication frame. At this time, the station apparatus can configure the transmit power for a data field of the direct communication frame based on the transmit power information included in the trigger frame. In other words, in a case of transmitting the direct communication frame, the station apparatus can configure different values of transmit power for a preamble part (L-SIG/L-LTF/L-STF/EHT-SIG/EHT-LTF/EHT-STF or the like) and a data part. The station apparatus can configure higher power for the preamble part than for the data part.

The station apparatus can describe, in the PHY header of the direct communication frame, information indicating that the direct communication frame is a direct communication frame. The station apparatus can configure a modulation scheme different from that for the communication frame, for a signal block constituting the direct communication frame. For example, the station apparatus can configure a modulation scheme different from that for the PHY header included in the communication frame, for a part of the PHY header included in the direct communication frame.

For a station apparatus allowed by the trigger frame to transmit the direct communication frame, in a case that a frame (OBSS frame) transmitted by a radio apparatus belonging to another BSS is received, and the OBSS frame describes information indicating that a change in carrier sense level is prohibited, then the station apparatus does not transmit the direct communication frame. In other words, the station apparatus according to the present embodiment can be configured to refrain from transmitting the direct communication frame in a case of recognizing that a radio apparatus belonging to another neighboring BSS is in a state in which the radio apparatus cannot allow interference power. The same applies to a case where a station apparatus allowed to transmit the direct communication frame receives an OBSS frame conforming to a legacy standard guaranteeing backward compatibility.

The station apparatus can include, in the direct communication frame, information associated with carrier sense performed by another station apparatus having received the direct communication frame. The station apparatus can include, in the direct communication frame, information indicating whether to perform carrier sense on the station apparatus serving as the destination of the direct communication frame. The station apparatus can include information indicating whether to allow for a change in carrier sense level for a station apparatus that is not the destination of the direct communication frame. The information indicating whether to allow for a change in carrier sense level may include information indicating allowable interference power for a station apparatus that transmits or receives the direct communication frame or information indicating transmit power configured in a case that a station apparatus that is not the destination of the direct communication frame performs frame transmission.

The information associated with the carrier sense can be included in the trigger frame transmitted by the access point apparatus. In other words, the access point apparatus can control the carrier sense performed in the direct communication radio resource.

The information indicating the transmit power included in the trigger frame can be information associated with a carrier sense level included in a frame transmitted by a radio apparatus belonging to another BSS and received by the station apparatus allowed to transmit the direct communication frame. In other words, the trigger frame can include information indicating to the station apparatus that the transmit power is configured based on the information associated with the carrier sense level described in the frame transmitted by the radio apparatus belonging to such another BSS.

The access point apparatus according to the present embodiment can use the trigger frame to configure direct communication in addition to uplink communication and downlink communication between the access point apparatus and the station apparatus. The access point apparatus according to the present embodiment can divide the radio resource reserved by the trigger frame into multiple radio resources and individually configure the above-described multiple communications for the respective multiple radio resources resulting from the division.

The trigger frame associated with the direct communication frame can reserve multiple radio resources, and can reserve the multiple radio resources in different time periods. In other words, the receiver of the access point according to the present embodiment can perform carrier sense to reserve, for the multiple radio resources, a radio medium in respective time periods with different lengths. At this time, in a case that the time periods for reserving the radio medium vary, the carrier sense can be performed on each radio resource with the same parameters (the length of the IFS, the value of the backoff counter, and the initial value of the backoff counter) or with different parameters. In a case that carrier sense is performed with different parameters, the longest carrier sense period can be configured for the radio resource for which the radio medium reserved in the longest time period by the access point apparatus is reserved.

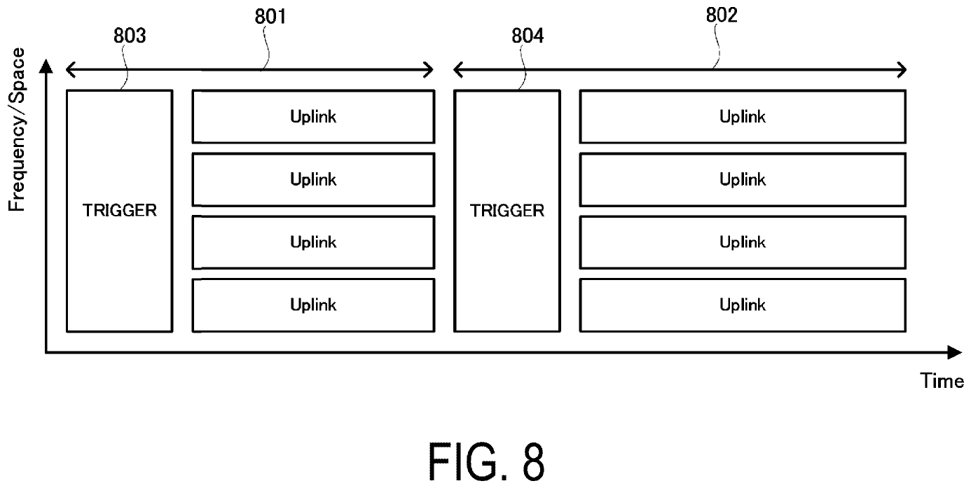

FIG. 8 is an overview diagram illustrating the state of known communication assumed according to the present embodiment. In the related art, the access point apparatus transmits a trigger frame 803 to reserve a radio resource for a time interval 801. In a case that allocation of a radio resource is configured for the station apparatus associated with the access point apparatus in the trigger frame, the station apparatus can transmit a radio frame subsequent to reception of the trigger frame. However, in a case that multiple station apparatuses simultaneously transmit radio frames by frequency multiplexing or spatial multiplexing based on the trigger frame, the lengths of the frames transmitted by the multiple station apparatuses need to be basically the same.

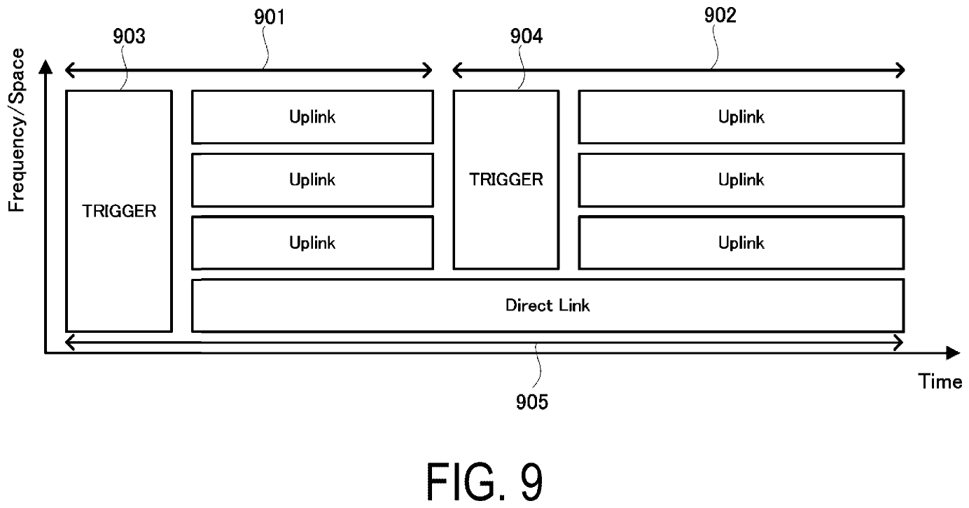

FIG. 9 is an overview diagram illustrating a state of communication according to the present embodiment. As illustrated in FIG. 9, the access point apparatus may reserve radio resources in two different time intervals such as a time interval 901 and a time interval 905 by the trigger frame 903. In other words, the access point apparatus can simultaneously acquire TXOPs with different lengths by the trigger frame 903. The access point apparatus can describe, in the trigger frame 903, the length of the time interval 901, the information indicating a radio resource reserved only in the time interval 901, the length of the time interval 905, and the information indicating a radio resource reserved only in the time interval 905. For example, as illustrated in FIG. 9, the access point apparatus can configure different communications in the radio resource reserved only in the time interval 901 and the radio resource reserved only in the time interval 905. In the example in FIG. 9, the access point apparatus can configure uplink communication from the station apparatus to the access point apparatus in the radio resource reserved only in the time interval 901, and can configure the direct communication between the station apparatuses in the radio resource reserved only in the time interval 905.

In the example in FIG. 9, the radio resources for which the access point apparatus acquires TXOPs with different lengths are limited to nothing. For example, the access point apparatus can divide a radio resource acquired by the access point apparatus into RUs each having a prescribed bandwidth and acquire TXOPs having different lengths for the respective RUs. Of course, the access point apparatus can configure different communication for each RU.

The trigger frame 903 allows TXOPs with different sizes to be reserved, and in a case that multiple frames are triggered by the trigger frame 903, the frame lengths of the multiple frames can have different values. Accordingly, the trigger frame 903 can describe information indicating the frame length of each of the multiple frames triggered by the trigger frame 903. Note that the trigger frame 903 can include control information indicating whether to perform carrier sense on the destination terminal of the trigger frame 903.

In a case of acquiring TXOPs with different lengths by the trigger frame, the access point apparatus can provide an attribute to each of the TXOPs (or each NAV triggered by the trigger frame). For example, the access point apparatus may describe, in the trigger frame, information indicating how the NAV is configured by the station apparatus having received the trigger frame and being not the destination terminal of the trigger frame. For example, the access point apparatus can describe, in the trigger frame, together with information indicating the length of the TXOP, information indicating which one of an Intra NAV or an Inter NAV is configured as the NAV corresponding to the length of the TXOP; the Intra NAV is associated with a frame belonging to the same BSS as the access point apparatus, and the Inter NAV is associated with a frame belonging to the OBSS.

The access point apparatus and the station apparatus can also configure the NAV associated with the direct communication. In a case of configuring the direct communication for a radio resource for which a TXOP has been acquired by the trigger frame, the access point apparatus can describe, in the trigger frame, information indicating that a NAV associated with the direct communication (hereinafter also referred to as a peer-to-peer NAV or a P2P NAV) is configured for a station apparatus having received the trigger frame and not corresponding to an allocated user of the radio resource. Even in a case that the explicit control information as described above is not configured, the P2P NAV for the time period (length of the TXOP) in which a radio resource is reserved can be configured by the station apparatus having received the trigger frame describing information indicating that the direct communication is configured for the radio resource, the station apparatus not corresponding to an allocated user of the radio resource.

The P2P NAV can be configured by a station apparatus belonging to a BSS managed by an access point apparatus having transmitted the trigger frame triggering the P2P NAV. On the other hand, even in a case of receiving the trigger frame, the station apparatus belonging to the OBSS can configure a NAV (for example, an Inter NAV) other than the P2P NAV for the radio resource in which the direct communication is configured.

The P2P NAV can be configured by a station apparatus configured as a Responder of the direct communication in the radio resource in which the direct communication is configured, among the station apparatuses belonging to the BSS managed by the access point apparatus having transmitted the trigger frame triggering the P2P NAV. Note that even in a case that the trigger frame contains no explicit description of a responder as described above, a station apparatus that is not configured as a Sender or an Initiator of the direct communication can configure the P2P NAV in the radio resource in which the direct communication is configured.

The P2P NAV can be updated based on the value of the TXOP acquired by the direct communication frame described in the direct communication frame. The sender of the direct communication can describe, in the direct communication frame, information indicating that the TXOP acquired by the direct communication frame is associated with the P2P NAV. For example, the PHY header of the direct communication frame can describe information indicating that the direct communication frame is a frame configured for the direct communication, information indicating that the update of the P2P NAV is allowed, and the like.

A station apparatus configured with multiple NAVs including the P2P NAV can plan to perform frame transmission (can transition to the carrier sense operation) in a case that all the NAVs are ended. However, even in a case that at least one of the multiple NAVs has not ended, the station apparatus can perform frame transmission based on the trigger frame describing information associated with each NAV. For example, in a case that the P2P NAV is configured, and the station apparatus receives, from the access point apparatus, the trigger frame indicating that the station apparatus is configured as the sender of the direct communication, then the station apparatus can update (discard) the P2P NAV and transmit the direct communication frame. Of course, the destination terminal of the direct communication frame is limited to the station apparatus described in the trigger frame. In a case that the trigger frame describes information (for example, transmit power, allowable interference power, or the like) associated with the transmission of the direct communication frame, the station apparatus can transmit the direct communication frame only in a case of being able to follow the information.

The access point apparatus can divide the radio resource reserved by the trigger frame into multiple RUs, and configure different communication for each of the RUs. At this time, the access point apparatus can include, in the trigger frame, information associated with the maximum transmit power that can be configured for each RU (or for each communication). The information associated with the maximum transmit power can be a value of the maximum transmit power, a value indicating a difference from a pre-configured value, or a value indicating interfered power allowed by the access point apparatus.

The method described above allows the direct communication between the station apparatuses to be efficiently performed, and enables a reduction in interference power resulting from the direct communication. This enables improvement of frequency utilization efficiency in a frequency band used by the communication system.

### 2. Matters Common for All Embodiments

Although the communication apparatuses according to the present embodiment can perform communication in a frequency band (frequency spectrum) that is a so-called unlicensed band that does not require permission to use from a country or a region, frequency bands usable are not limited thereto. Although permission to use a specific service is given from a country or a region, the communication apparatuses according to an aspect of the present invention can exhibit the effect that can be brought by the purpose of preventing interference between frequencies, and the like, in a frequency band called a white band that is not actually used (e.g., a frequency band that is allocated for television broadcasting but is not used depending on regions), or a shared spectrum (shared frequency band) that is expected to be shared by multiple service providers, for example.

In addition, a communication standard to be applied to the communication apparatuses according to an aspect of the present invention is not limited. For example, in a case that a communication standard (e.g., a communication standard approved as IMT-Advanced or a communication standard approved as IMT-2020 by the ITU-R) mostly applied to a frequency band for which permission to use should be acquired from a country or a region, that is called a licensed band, is introduced into an unlicensed band, the same effects can be exhibited also in the communication standard.

A program operated in the radio communication apparatuses according to an aspect of the present invention is a program (a program for causing a computer to function) for controlling a CPU or the like to implement the functions of the aforementioned embodiments according to an aspect of the present invention. In addition, information handled by these apparatuses is temporarily accumulated in a RAM at the time of processing, is then stored in various types of ROMs and HDDs, and is read by the CPU as necessary to be corrected and written. A semiconductor medium (e.g., a ROM, a non-volatile memory card, or the like), an optical recording medium (e.g., a DVD, an MO, an MD, a CD, a BD, or the like), a magnetic recording medium (e.g., a magnetic tape, a flexible disk, or the like), and the like can be examples of recording media for storing programs. In addition to implementing the functions of the aforementioned embodiments by performing loaded programs, the functions of the present invention may be implemented in processing performed in cooperation of an operating system, other application programs, and the like based on instructions of those programs.

In a case of delivering these programs to market, the programs can be stored and distributed in a portable recording medium, or transferred to a server computer connected via a network such as the Internet. In this case, storage apparatuses of the server computer are also included in an aspect of the present invention. A part or an entirety of the communication apparatuses in the aforementioned embodiments may be implemented as an LSI that is typically an integrated circuit. The functional blocks of the communication apparatuses may be individually implemented as chips or may be partially or completely integrated into a chip. In a case that the functional blocks are made as integrated circuits, an integrated circuit controller for controlling them is added.

The circuit integration technique is not limited to LSI, and may be realized as dedicated circuits or a multi-purpose processor. Moreover, in a case that a circuit integration technology that substitutes an LSI appears with the advance of the semiconductor technology, it is also possible to use an integrated circuit based on the technology.

Note that, the invention of the present application is not limited to the above-described embodiments. The radio communication apparatus according to the invention of the present application is not limited to the application in the mobile station apparatus, and, needless to say, can be applied to a fixed-type electronic apparatus installed indoors or outdoors, or a stationary-type electronic apparatus, for example, an AV apparatus, a kitchen apparatus, a cleaning or washing machine, an air-conditioning apparatus, office equipment, a vending machine, and other household apparatuses.

Although the embodiments of the invention have been described in detail above with reference to the drawings, a specific configuration is not limited to the embodiments, and designs and the like that do not depart from the essential spirit of the invention also fall within the claims.

### INDUSTRIAL APPLICABILITY

An aspect of the present invention can be preferably used in an access point apparatus and a communication method.

### ASPECT OF THE PRESENT INVENTION

### Reference Signs List

1-1, 1-2 Access point apparatus
2-1 to 8 Station apparatus
3-1, 3-2 Control range
10001-1 Higher layer unit
10002-1 Autonomous distributed controller
10002a-1 CCA unit
10002b-1 Backoff unit
10002c-1 Transmission determination unit
10003-1 Transmitter
10003a-1 Physical layer frame generator
10003b-1 Radio transmitter
10004-1 Receiver
10004a-1 Radio receiver
10004b-1 Signal demodulator
10005-1 Antenna unit

1. An access point apparatus for communicating with multiple station apparatuses, the access point apparatus comprising:
a transmitter configured to transmit a trigger frame triggering frame transmission performed by each of the multiple station apparatuses; and
a receiver configured to perform carrier sense to reserve multiple radio resources in time periods with different lengths, wherein
the trigger frame includes information indicating the time periods for the multiple radio resources reserved by the receiver.

2. The access point apparatus according to claim 1, wherein
the trigger frame is configured to configure first communication that is communication between the multiple station apparatuses and second communication that is communication between the access point apparatus and the multiple station apparatuses, and
the trigger frame includes information associated with transmit power for a frame where the first communication is configured.

3. The access point apparatus according to claim 2, wherein
the information described in the trigger frame and indicating the time periods triggers configuration of NAVs with different attributes for the station apparatus having received the trigger frame.

4. The access point apparatus according to claim 3, wherein
an attribute of a NAV triggered by the trigger frame is a NAV that is allowed to be updated by a station apparatus where the first communication is configured.

5. A communication method for an access point apparatus communicating with multiple station apparatuses, the communication method comprising the steps of:
transmitting a trigger frame triggering frame transmission performed by each of the multiple station apparatuses; and
performing carrier sense to reserve multiple radio resources in time periods with different lengths, wherein
the trigger frame includes information indicating the time periods for the multiple radio resources reserved by the carrier sense.
